(19) United States
(12) Patent Application Publication
(10) Pub. No.: US 2023/0023337 A1
(43) Pub. Date: Jan. 26, 2023

(54) SYSTEMS, DEVICES AND METHODS FOR CONTENT CREATION REQUESTSAND RESPONSES

(71) Applicants: John Clarke Jackson, Bethesda, MD (US); Brian Eugene Cunningham, Severn, MD (US); Travis Ames Hurant, Chapel Hill, NC (US)

(72) Inventors: John Clarke Jackson, Bethesda, MD (US); Brian Eugene Cunningham, Severn, MD (US); Travis Ames Hurant, Chapel Hill, NC (US)

(73) Assignee: Indi Individuals, Inc., Newport Beach, CA (US)

(21) Appl. No.: 17/443,348

(22) Filed: Jul. 26, 2021

(51) Int. Cl. G06Q 50/18; G06Q 30/02

(52) U.S. Cl. CPC G06Q 50/188; G06Q 30/0283

(57) ABSTRACT

Certain exemplary embodiments can provide a method that can include: sending software to a first information device and to a second information device, the software adapted to enable the user of the first information device to create a request that content be created by the user of the second information device; providing the content of that request to the software running on the second information device, the software adapted to cause the content of the request to be rendered via the second information device; the software further adapted to enable the user of the second information device to create a response to the request; and providing the content of that response to the software running on the first information device, the software adapted to cause the content of the response to be rendered via the first information device.

### CROSS-REFERENCE TO RELATED APPLICATION

This application claims priority to, and incorporates by reference herein in its entirety, pending U.S. Provisional Patent Application 62/706,133, filed Aug. 2, 2020.

### FIELD OF THE INVENTION

The present invention relates to novel systems and methods for requesting the creation of custom content and fulfilling the responses to such requests. More particularly, the invention relates to the compensation for such requests, the nature of the requests, the fulfillment of the requests and the like.

### BACKGROUND

Requesting video content creation, commonly referred to as a shoutout from users such as celebrities, has become a popular fee-based service on platforms such as Cameo. However, certain platforms suffer from drawbacks that hinder the process of requesting the creation of custom content and fulfilling the response to such requests.

These platforms typically limit customers to short written requests, which precludes a request for feedback or commentary on customer-submitted videos, photos, audio, documents or other media.

These platforms also typically require a content creator to set a fixed price for fulfilling a request which can result in a disconnect between the willingness of consumers to pay a particular price and the willingness of a content creator to fulfill requests for a particular price.

These platforms also typically set a fixed time period by which the content creator must respond to the request before the request expires, which can results in a disconnect between the time that a consumer is willing to wait for the request to be fulfilled and the time in which a content create is able or willing to fulfill such a request.

Therefore, a need exists for novel systems and methods for requesting the creation of custom content and fulfilling the response to such requests that facilitate a request for feedback or commentary on customer-submitted videos, photos, audio, documents or other media.

Furthermore, a need exists for novel systems and methods for requesting the creation of custom content and fulfilling the response to such requests that include more flexible pricing options.

Additionally, a need exists for novel systems and methods for setting a variable time period by which the content creator must respond to the request before the request expires.

### BRIEF SUMMARY OF THE INVENTION

Certain exemplary embodiments can provide systems and/or methods for the user of a first information device to request that content be created by the user of a second information device and delivered to the user of a first information device. Such content may include, but is not limited to, videos, photos, audio, text, documents or other media or content.

Certain exemplary embodiments can allow the first device user to include additional media, including but not limited to videos, photos, audio, text, documents or other media or content as part of the request to the second device user. Such media can be viewed, reviewed or otherwise consumed by the second device user as part of the process of creating the content for the response to be delivered to the first device user.

Certain exemplary embodiments can allow the first device user to include an offer price as part of the request to the second device user. Such offer price presented to the second device user as part of the process for deciding whether to accept, reject or ignore the request from the first device user.

Certain exemplary embodiments can allow the first device user to set a request expiration time, date, period and/or other duration for responding to a request, and to include such request expiration as part of the request to the second device user. Such request expiration presented to the second device user along with other information related to the request.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system;

FIG. 2 is a flowchart of an exemplary embodiment of a method;

FIG. 3 is a flowchart of an exemplary embodiment of a method; and

FIG. 4 is a flowchart of an exemplary embodiment of a method.

### DETAILED DESCRIPTION OF THE INVENTION

Certain exemplary embodiments can provide systems and/or methods that can include: sending software to a first information device and to a second information device, the software adapted to enable the user of the first information device to create a request that content be created by the user of the second information device; providing the content of that request to the software running on the second information device, the software adapted to cause the content of the request to be rendered via the second information device; the software further adapted to enable the user of the second information device to create a response to the request; and providing the content of that response to the software running on the first information device, the software adapted to cause the content of the response to be rendered via the first information device. Such content may include, but is not limited to, videos, photos, audio, text, documents or other media or content.

Certain exemplary embodiments can allow the first device user to request that a single piece of content be created by the second device user.

Certain exemplary embodiments can allow the first device user to request that multiple pieces of content be created by the second device user.

Certain exemplary embodiments can allow the second device user to accept and fulfill the request by the first device user.

Certain exemplary embodiments can allow the second device user to accept and immediately or nearly immediately fulfill the request by the first device user.

Certain exemplary embodiments can allow the second device user to accept and then fulfill the request by the first device user at a later time.

Certain exemplary embodiments can allow the second device user to reject the request by the first device user, resulting in the request not being fulfilled by the second device user.

Certain exemplary embodiments can allow the second device user to accept and then later reject the request by the first device user, resulting in the request not being fulfilled by the second device user.

Certain exemplary embodiments can allow the second device user to ignore the request by the first device user, resulting in the request not being fulfilled by the second device user.

Certain exemplary embodiments can require that the second device user fulfill the request by the first device user within a certain time period, after such time the request will expire if not fulfilled, resulting in the request no longer being available for fulfillment by the second device user.

Certain exemplary embodiments can allow the second device user to block the first device user from making future requests.

Certain exemplary embodiments can allow the second device user to deliver a single piece of content in the response to the request by the first device user.

Certain exemplary embodiments can allow the second device user to deliver multiple pieces of content in the response to the request by the first device user.

Certain exemplary embodiments can allow the second device user to request clarification, additional information, or subsequent communication from the first device user prior to the second device user responding to the request.

Certain exemplary embodiments can allow the first device user to provide clarification, additional information, or subsequent communication to the second device user prior to the second device user responding to the request.

Certain exemplary embodiments can allow the second device user to create and deliver new content in the response to the request by the first device user.

Certain exemplary embodiments can allow the second device user to select and deliver existing content in the response to the request by the first device user.

Certain exemplary embodiments can allow the second device user to deliver live content, such as one or two way video streaming, audio streaming, video conferencing, screen sharing or any other form of live, real-time, or nearly real-time communication as part or as the entirety of the response to the request by the first device user.

### Requests Including Additional Media

Certain exemplary embodiments can allow the user of the first information device to include additional media, including but not limited to videos, photos, audio, text, documents or other media; and providing that media as part of the content of the request to the software running on the second information device, the software adapted to cause the content of the request along with that media to be rendered via the second information device.

Certain exemplary embodiments can allow the second device user to view, review or otherwise consume the included additional media prior to accepting, rejecting, or otherwise responding to or fulfilling the request by the first device user.

Certain exemplary embodiments can allow the second device user to bookmark, highlight, flag or otherwise mark for later use and/or ease of locating or reference the whole, or one or more sections, subsections, screens, images, timecodes, words, phrases, clips and/or any other such part, of any included media, content or other parts of the request made by the first device user.

Certain exemplary embodiments can allow the second device user to attach, include, insert, paste or otherwise incorporate the whole, or one or more sections, subsections, screens, images, timecodes, words, phrases, clips and/or any other such part, of any included media, content or other parts of the request, in the creation or fulfillment of the response to the first device user.

Certain exemplary embodiments can allow the second device user to annotate or otherwise mark with notes, words, symbols, drawings, audio, video, images or other methods of adding or including information to the whole, or to one or more sections, subsections, screens, images, timecodes, words, phrases, clips and/or any other such parts, of any included media, content or request by the first device user. Such annotations can remain private for use by the second device user and/or included in whole or part in the response to the first device user.

### Request Pricing

Certain exemplary embodiments can allow the system and/or the second device user to provide a price for fulfillment of a request; and providing that price to the software running on the first information device, the software adapted to cause that price to be rendered via the first information device.

Certain exemplary embodiments can allow for the first device user to pay a price as part of the process of making a request to the second device user.

Certain exemplary embodiments can allow for the first device user to provide a form of payment as part of the process of making a request to the second device user.

Certain exemplary embodiments can allow for the system to charge the form of payment provided by the first device user.

Certain exemplary embodiments can allow for the system to place a hold on the form of payment provided by the first device user.

Certain exemplary embodiments can allow for the system to capture the charge for a hold placed on the form of payment provided by the first device user after the request is fulfilled by the second device user.

Certain exemplary embodiments can allow for the second device user to receive payment after responding to or otherwise fulfilling the request made by the first device user.

Certain exemplary embodiments can allow for the first device user to receive a refund if the request is not fulfilled by the second device user.

Certain exemplary embodiments can allow for the system to release a hold on the form of payment provided by the first device user if the request is not fulfilled by the second device user.

Certain exemplary embodiments can allow a system user and/or the second device user to set a price directly.

Certain exemplary embodiments can allow a single price for the entire system.

Certain exemplary embodiments can allow different prices for different users and/or requests in the system.

Certain exemplary embodiments can allow the system and/or the second device user to provide a price automatically using one or more algorithms incorporating algorithm input data as defined herein.

### Offer-Based Pricing

Certain exemplary embodiments can allow the first device user to include an offer price for fulfillment of a request; and providing that offer price as part of the content of the request to the software running on the second information device, the software adapted to cause the content of the request along with that offer price to be rendered via the second information device.

Certain exemplary embodiments can allow the second device user to view, review or otherwise be aware of the offer price prior to accepting, rejecting, or otherwise responding to the request by the first device user.

### Recommended Offer Prices

Certain exemplary embodiments can allow the system and/or the second device user to provide a recommended offer price. Such recommended offer price can be communicated to and can provide guidance to the first device user when that user is deciding on an offer price to include as part of the request to the second device user.

Certain exemplary embodiments can allow a system user and/or the second device user to set a recommended offer price directly.

Certain exemplary embodiments can allow a single recommended price for the entire system.

Certain exemplary embodiments can allow different recommended prices for different users and/or requests in the system.

Certain exemplary embodiments can allow the system and/or the second device user to provide a recommended offer price automatically using one or more algorithms incorporating algorithm input data as defined herein.

### Minimum Offer Prices

Certain exemplary embodiments can allow the system and/or the second device user to provide a minimum offer price. Such minimum offer price can be communicated to and can provide a lower price limit to the first device user when that user is deciding on an offer price to include as part of the request to the second device user.

Certain exemplary embodiments can allow a system user and/or the second device user to set a minimum offer price directly.

Certain exemplary embodiments can allow a single minimum offer price for the entire system.

Certain exemplary embodiments can allow different minimum offer prices for different users and/or requests in the system.

Certain exemplary embodiments can allow the system and/or the second device user to provide a minimum offer price automatically using one or more algorithms incorporating algorithm input data as defined herein.

### Maximum Offer Prices

Certain exemplary embodiments can allow the system and/or the second device user to provide a maximum offer price. Such maximum offer price can be communicated to and can provide an upper price limit to the first device user when that user is deciding on an offer price to include as part of the request to the second device user.

Certain exemplary embodiments can allow a system user and/or the second device user to set a maximum offer price directly.

Certain exemplary embodiments can allow a single maximum offer price for the entire system.

Certain exemplary embodiments can allow different maximum offer prices for different users and/or requests in the system.

Certain exemplary embodiments can allow the system and/or the second device user to provide a maximum offer price automatically using one or more algorithms incorporating algorithm input data as defined herein.

### Counter-Offer Prices

Certain exemplary embodiments can allow the system and/or the second device user to provide a counter-offer price in the event that an offer price included as part of a request from the first device user is considered too low to be accepted by the second device user. Such counter-offer price can be communicated to the first device user can indicate an offer price that the second device user would be willing to accept for fulfilling the request from the first device user.

Certain exemplary embodiments can allow a system user and/or the second device user to set a counter-offer price directly.

Certain exemplary embodiments can allow the system and/or the second device user to provide a counter-offer price automatically using one or more algorithms incorporating algorithm input data as defined herein.

Certain exemplary embodiments can allow the system to provide a recommended counter-offer price automatically using one or more algorithms incorporating algorithm input data as defined herein, providing guidance when a system user and/or the second device user are setting a counter-offer price directly.

### Response-Time Based Price Schedules

Certain exemplary embodiments can allow the system and/or the user of the first information device and/or the user of the second information device to set different prices for fulfillment of a request based on the response time to fulfill the request; and providing such price schedule as part of the content of the request to the software running on the first information device and/or the software running on the second information device, the software adapted to cause that price schedule to be rendered via the first information device and/or the second information device. For example, the second device user might: receive $100 if the request from the first device user is fulfilled within 24 hours; $50 if the request is fulfilled between 24 and 48 hours; and $25 if the request is fulfilled after 48 hours.

Certain exemplary embodiments can allow a system user and/or the first device user and/or the second device user to set a price schedule directly.

Certain exemplary embodiments can allow the system and/or the second device user to provide a price schedule automatically using one or more algorithms incorporating algorithm input data as defined herein.

### Request Queue

Certain exemplary embodiments can allow the system to receive and store a list of multiple requests made by one or more users of information devices; and providing that list in whole or in part to the software running on the second information device, the software adapted to cause that list to be rendered via the second information device.

Certain exemplary embodiments can allow the second device user to view the details of one or more requests from the list.

Certain exemplary embodiments can allow the second device user to interact with one or more requests in the list, including but not limited to the ability to accept, reject, make a counter offer, fulfill or otherwise respond to a request or requests from the list.

Certain exemplary embodiments can allow the second device user to view the list of requests sorted and/or filtered by attributes and/or aspects of and/or characteristics related to the requests in the list. Such attributes, aspects and/or characteristics including but not limited to the type, nature, duration, date, expiration, complexity and/or other aspects of the requests themselves and/or the type, nature, duration, complexity and/or other aspects related to any additional media included with the requests.

Certain exemplary embodiments can allow the second device user to view the list of requests sorted and/or filtered by the difference, percentage or ratio between the fixed price or offer prices for the request and another price or prices, including but not limited to the recommended price and/or the average price for requests accepted by the second device user.

### Level-Of-Effort Indicator

Certain exemplary embodiments can allow the system and/or the second device user to provide an anticipated, estimated and/or otherwise calculated or entered level-of-effort number, flag, rating, score, metric and/or other such indicator.

Certain exemplary embodiments can allow a level-of-effort indicator to be communicated or otherwise displayed to the second device user.

Certain exemplary embodiments can allow a level-of-effort indicator to be used to provide guidance to the second device user when making the decision to accept, reject, fulfill and/or otherwise respond to and/or prioritize the response to one or more requests.

Certain exemplary embodiments can allow a system user and/or the second device user to set a level-of-effort indicator directly.

Certain exemplary embodiments can allow the system and/or the second device user to provide a level-of-effort indicator automatically using one or more algorithms incorporating algorithm input data as defined herein.

Certain exemplary embodiments can allow the second device user to view the list of requests sorted and/or filtered by level-of-effort indicators.

### Value-For-Effort Indicator

Certain exemplary embodiments can allow the system and/or the second device user to provide an anticipated, estimated and/or otherwise calculated or entered value-for-effort number, flag, rating, score, metric and/or other such indicator. Such indicator intended to indicate a relationship between a price associated with a request and the level-of-effort indicator associated with a request.

Certain exemplary embodiments can allow a value-for-effort indicator to be communicated or otherwise displayed to the second device user.

Certain exemplary embodiments can allow a value-for-effort indicator to be used to provide guidance to the second device user when making the decision to accept, reject, fulfill and/or otherwise respond to and/or prioritize the response to one or more requests.

Certain exemplary embodiments can allow a system user and/or the second device user to set a value-for-effort indicator directly.

Certain exemplary embodiments can allow the system and/or the second device user to provide a value-for-effort indicator automatically using one or more algorithms incorporating algorithm input data as defined herein.

Certain exemplary embodiments can allow the second device user to view the list of requests sorted and/or filtered by value-for-effort indicators.

### Requests With Variable Expiration Time

Certain exemplary embodiments can allow the system and/or the user of the first information device and/or the user of the second information device to set a request expiration time, date, period and/or other duration for responding to a request; and providing such request expiration as part of the content of the request to the software running on the first information device and/or the software running on the second information device, the software adapted to cause that request expiration to be rendered via the first information device and/or the second information device.

Certain exemplary embodiments can allow a single request expiration for the entire system.

Certain exemplary embodiments can allow different request expirations for different users and/or requests in the system.

Certain exemplary embodiments can allow a system user and/or the first device user and/or the second device user to set a request expiration directly.

Certain exemplary embodiments can allow the system and/or the second device user to provide a request expiration using one or more algorithms incorporating algorithm input data as defined herein.

### Drawings

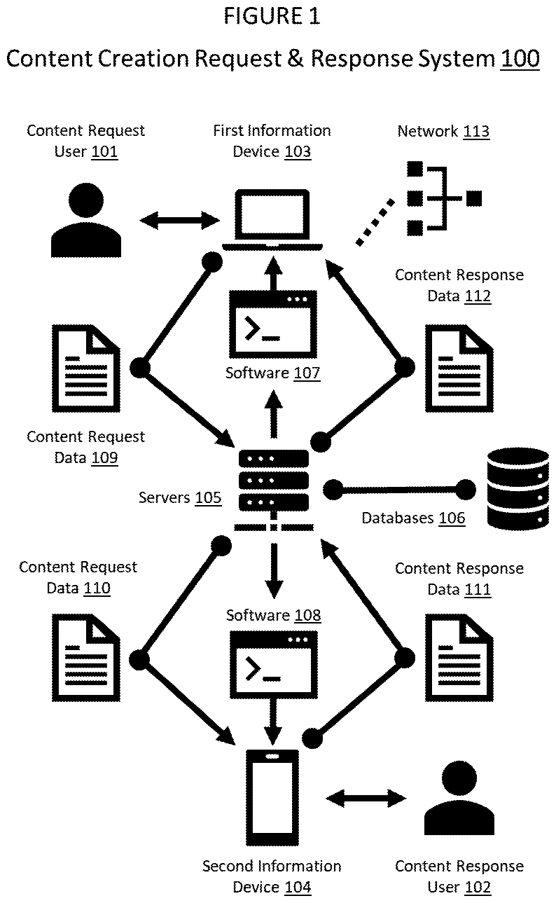

FIG. 1 is a block diagram of an exemplary embodiment of a system 100 which can comprise any number of information devices 103, 104, which can be communicatively coupled via a network 113.

Also coupled to network 113 can be any number of servers 105. A server can include a server software application. A server can be coupled to a data storage device, repository, and/or databases 106. A server can include an administrator user interface and/or database management software.

Certain exemplary embodiments include: sending software 107, 108 to a first information device 103 and a second information device 104, the software 107 adapted to enable the user 101 of the first information device 103 to create a request that content be created by the user 102 of the second information device 104; providing the content of that request 109, 110 to the software running on the second information device 104, the software 108 adapted to cause the content of the request 109, 110 to be rendered via the second information device 104; the software 108 further adapted to enable the user 102 of the second information device 104 to create a response to the request; and providing the content of that response 111, 112 to the software 107 running on the first information device 103, the software 107 adapted to cause the content of the response 111, 112 to be rendered via the first information device 103.

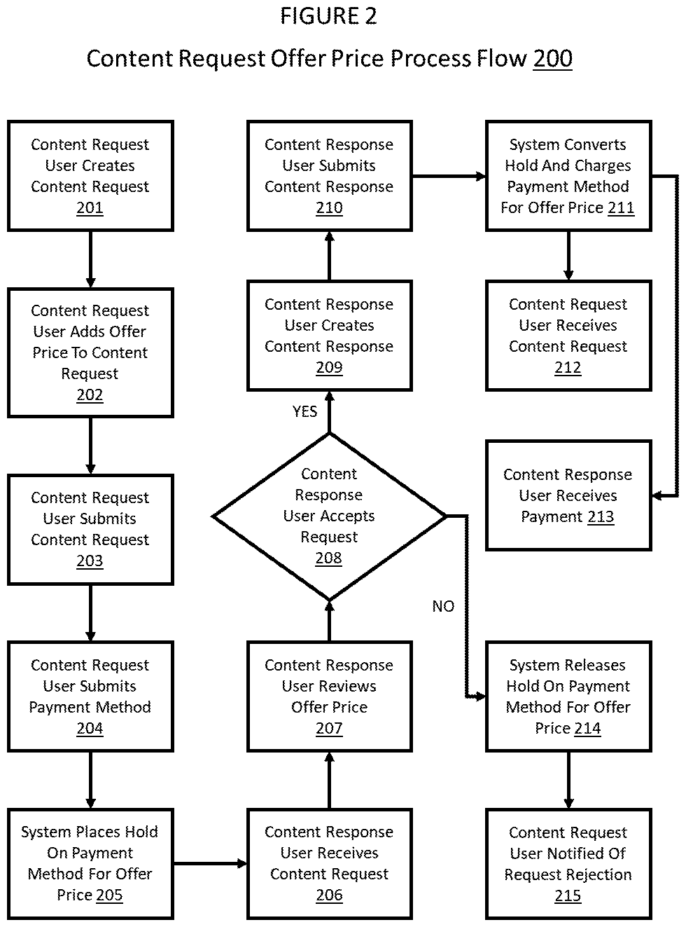

FIG. 2 is a flowchart of an exemplary embodiment of a method in which a first user creates a content request 201.

Certain exemplary embodiments include the ability for the first user to: add an offer price to the content request 202; submit the content request 203; and/or submit a payment method for the content request 204.

Certain exemplary embodiments include the ability to charge and/or place a hold on and/or otherwise verify the submitted payment method 205.

Certain exemplary embodiments include the ability for a second user to: receive the content request 206; review the offer price 207; accept or reject the content request 208; create a response to the content request 209; and/or submit the response to the content request 210.

Certain exemplary embodiments include the ability to convert the hold and/or otherwise charge the submitted payment method 211.

Certain exemplary embodiments include the ability for the first user to receive the response to the content request 212.

Certain exemplary embodiments include the ability for the second user to receive payment for the response to the content request 213.

Certain exemplary embodiments include the ability to release the hold on and/or otherwise refund a charge made to the submitted payment method 214.

Certain exemplary embodiments include the ability for the first user to receive a notification of the rejection of the content request by the first user 215.

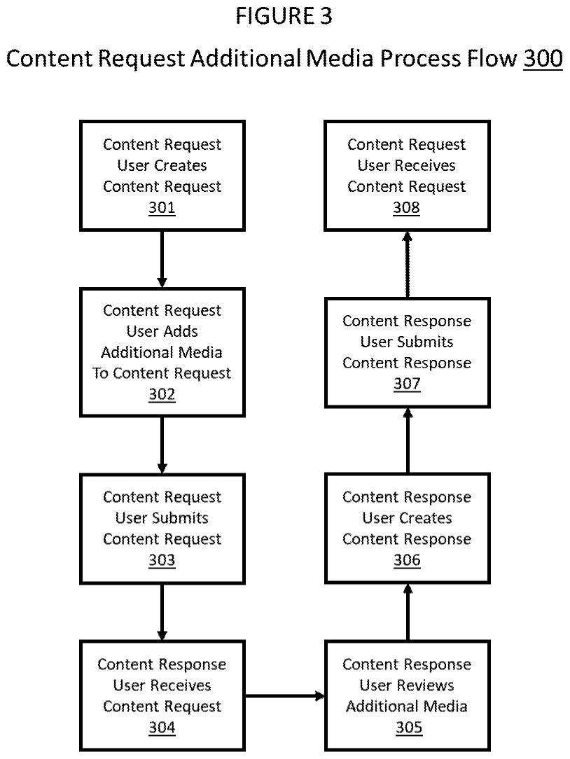

FIG. 3 is a flowchart of an exemplary embodiment of a method in which a first user creates a content request 301.

Certain exemplary embodiments include the ability for the first user to: add an additional media to the content request 302; and/or submit the content request 303.

Certain exemplary embodiments include the ability for a second user to: receive the content request 304; review the additional media 305; create a response to the content request 306; and/or submit the response to the content request 307.

Certain exemplary embodiments include the ability for the first user to receive the response to the content request 308.

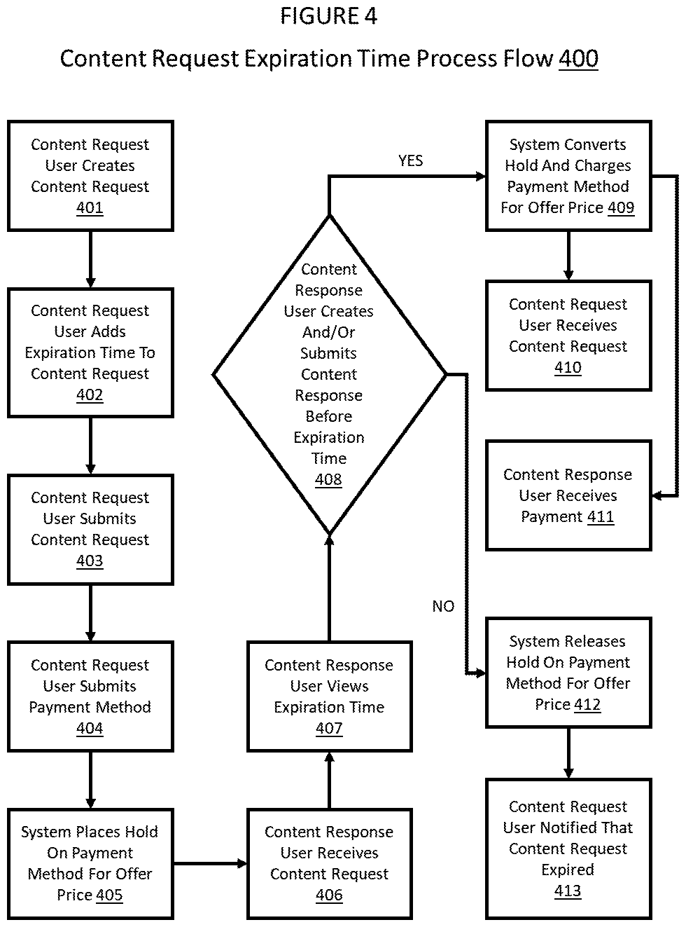

FIG. 4 is a flowchart of an exemplary embodiment of a method in which a first user creates a content request 401.

Certain exemplary embodiments include the ability for the first user to: add an expiration time to the content request 402; submit the content request 403; and/or submit a payment method for the content request 404.

Certain exemplary embodiments include the ability to charge and/or place a hold on and/or otherwise verify the submitted payment method 405.

Certain exemplary embodiments include the ability for a second user to: receive the content request 406; view the expiration time 407; create a response to the content request and/or submit the response to the content request before the expiration time 408.

Certain exemplary embodiments include the ability to convert the hold and/or otherwise charge the submitted payment method 409.

Certain exemplary embodiments include the ability for the first user to receive the response to the content request 410.

Certain exemplary embodiments include the ability for the second user to receive payment for the response to the content request 411.

Certain exemplary embodiments include the ability to release the hold on and/or otherwise refund a charge made to the submitted payment method 412.

Certain exemplary embodiments include the ability for the first user to receive a notification of the expiration of the content request 413.

### Algorithm Input Data

When the term algorithm input data is used substantively herein, algorithm input data shall be defined as including, but not limited to, data, information and/or other factors, including:
transaction, processing, fulfillment and/or other costs;
the popularity of individual, segmented and/or collective users in the system;
the probability of fraud by individual, segmented and/or collective users in the system;
initial price, current price, offer price, recommended offer price, counter-offer price and/or other price or prices associated with one or more requests by individual, segmented and/or collective users in the system, including but not limited to the current request or requests and/or previously accepted, rejected, fulfilled and/or ignored requests;
response times for requests previously accepted, rejected, fulfilled and/or ignored by individual, segmented and/or collective users in the system;
the current and/or anticipated request volume for individual, segmented and/or collective users in the system;
attributes or aspects of and/or characteristics related to one or more requests made by individual, segmented and/or collective users in the system. Such attributes, aspects and/or characteristics including but not limited to the type, nature, duration, complexity and/or other aspects of the request or requests and/or the type, nature, duration, date, expiration, complexity and/or other aspects related to any additional media included with the request or requests; and/or
attributes or aspects of and/or characteristics related to the anticipated response or responses by individual, segmented and/or collective users in the system to a request or requests. Such attributes, aspects and/or characteristics including but not limited to the type, nature, duration, date, expiration, complexity and/or other aspects of the anticipated response or responses and/or the type, nature, duration, complexity and/or other aspects related to any additional media anticipated to be included with the response or responses.

### Definitions

When the following terms are used substantively herein, the accompanying definitions apply. These terms and definitions are presented without prejudice, and, consistent with the application, the right to redefine these terms via amendment during the prosecution of this application or any application claiming priority hereto is reserved. For the purpose of interpreting a claim of any patent that claims priority hereto, each definition in that patent functions as a clear and unambiguous disavowal of the subject matter outside of that definition.
a—at least one.
activity—an action, act, step, and/or process or portion thereof
adapted to—made suitable or fit for a specific use or situation.
algorithm—an algorithm may include, but is not limited to, a calculation, process, set of rules, problem-solving operation, mathematical formula, software program, machine instructions, machine learning, artificial intelligence or neural network.
and/or—either in conjunction with or in alternative to.
apparatus—an appliance or device for a particular purpose.
associate—to join, connect together, and/or relate.
automatically—acting or operating in a manner essentially independent of external influence or control. For example, an automatic light switch can turn on upon “seeing” a person in its view, without the person manually operating the light switch.
backbone network—a “transit” network often made up of long-distance telephone trunk lines and/or other wired and/or wireless links such as microwave and satellite links for use in transmitting large amounts of data simultaneously between host computer systems connected to the Internet. Normal communicated data typically neither originates nor terminates in a backbone network.
Boolean logic—a complete system for logical operations.
can—is capable of, in at least some embodiments.
cause—to produce an effect.
circuit—a physical system comprising: an electrically conductive pathway and/or a communications connection established across a switching device (such as logic gates); and/or an electrically conductive pathway and/or a communications connection established across two or more switching devices comprised by a network and between corresponding end systems connected to, but not comprised by the network.
comprising—including but not limited to.
configure—to make suitable or fit for a specific use or situation. containing—including but not limited to. convert—to transform, adapt, and/or change. create—to bring into being.
content—content may include, but is not limited to, videos, photos, audio, text, documents or other media or content.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the outline, form, or structure of
determine—to obtain, calculate, decide, deduce, and/or ascertain.
device—a machine, manufacture, and/or collection thereof digital—non-analog and/or discrete.
estimate—to calculate and/or determine approximately and/or tentatively.
first device user—user of the first information device.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
having—including but not limited to.
human-machine interface—hardware and/or software adapted to render information to a user and/or receive information from the user; and/or a user interface.
including—including but not limited to.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as an iPhone and/or Galaxy-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions, which can be implemented as firmware and/or software, the directions adapted to perform a particular operation or function.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. Thus, each electronic logic gate typically requires power so that it can source and/or sink currents to achieve the correct output voltage. Typically, machine instructions are ultimately encoded into binary values of “0”s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine instructions. This is one of the basic concepts underlying digital computing. At the register and/or gate level, a computer does not treat these “0”s and “1”s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine instructions. For example, if the encoding request a calculation, the logic gates might add the first two bits of the encoding together, produce a result “1” (“0”+“1”=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can store and/or obtain machine-implementable instructions, data, and/or information. Examples include a memory device, punch cards, etc.
may—is allowed and/or permitted to, in at least some embodiments.
media—media may include, but is not limited to, videos, photos, audio, text, documents or other media or content.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
method—one or more acts that are performed upon subject matter to be transformed to a different state or thing and/or are tied to a particular apparatus, said one or more acts not a fundamental principal and not pre-empting all uses of a fundamental principal.
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, ethernet card, cable modem, digital subscriber line interface, bridge, hub, router, or other similar device, software to manage such a device, and/or software to provide a function of such a device.
packet—a generic term for a bundle of data organized in a specific way for transmission, such as within and/or across a network, such as a digital packet-switching network, and comprising the data to be transmitted and certain control information, such as a destination address.
perceptible—capable of being perceived by the human senses. physical—tangible, real, and/or actual.
physically—existing, happening, occurring, acting, and/or operating in a manner that is tangible, real, and/or actual. plurality—the state of being plural and/or more than one.
predetermined—established in advance.
probability—a quantitative representation of a likelihood of an occurrence.
processor—a hardware, firmware, and/or software machine and/or virtual machine physically adaptable to perform, via boolean logic operating on a plurality of logic gates, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
project—to calculate, estimate, or predict.
provide—to furnish, supply, give, and/or make available.
receive—to get as a signal, take, acquire, and/or obtain.
recommend—to suggest, praise, commend, and/or endorse.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
second device user—user of the second information device.
select—to make a choice or selection from alternatives.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
special purpose computer—a computer and/or information device comprising a processor device having a plurality of logic gates, whereby at least a portion of those logic gates, via execution of specific machine instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine instructions to the logic gate's specific configuration and property(ies). In the context of an electronic computer, each such change in the logic gates creates a specific electrical circuit, thereby directly tying the specific machine instructions to that specific electrical circuit.
special purpose processor—a processor device, having a plurality of logic gates, whereby at least a portion of those logic gates, via execution of specific machine instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine instructions to the logic gate's specific configuration and property(ies). In the context of an electronic computer, each such change in the logic gates creates a specific electrical circuit, thereby directly tying the specific machine instructions to that specific electrical circuit.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
system user—an administrative and/or system-level user with appropriate permissions in a system.
transform—to change in measurable: form, appearance, nature, and/or character.
transmit—to send as a signal, provide, furnish, and/or supply.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
weight—a value indicative of importance.

### Notes

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise: there is no requirement for the inclusion of any particular described or illustrated characteristic, function, activity, or element, any particular sequence of activities, or any particular interrelationship of elements; no characteristic, function, activity, or element is “essential”; any elements can be integrated, segregated, and/or duplicated; any activity can be repeated, any activity can be performed by multiple entities, and/or any activity can be performed in multiple jurisdictions; and any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
from a server, sending content request software to a first information device, the software adapted to enable the user of the first information device to create a request that content be created by the user of a second information device;
at said server, from said content request software running on said first information device, receiving data associated with said request;
from said server, sending content response software to said second information device;
via said server, creating a communication session linking said second information device to said server;
from said server, providing data associated with said request to said content response software running on said second information device, receipt of said data associated with said request by said content response software running on said second information device adapted to cause information associated with said request to be rendered via said second information device, said content response software running on said second information device further adapted to enable the user of the second information device to create content in response to information associated with said request from said user of the first information device;
at said server, from said content response software running on said second information device, receiving data associated with said response; and
from said server, providing data associated with said response to said content request software running on said first information device, receipt of said data associated with said response by said content request software running on said first information device adapted to cause information associated with said response to be rendered via said first information device.

2. The method of claim 1, further comprising:
said content request software running on said first information device further adapted to enable the user of the first information device to include an offer price with said request.

3. The method of claim 2, wherein:
the inclusion of an offer price by the user of the first information device is preceded by, from said server, providing a recommended offer price to said content request software running on said first information device, receipt of said recommended offer price adapted to cause said recommended offer price to be rendered via said first information device.

4. The method of claim 1, wherein:
said content request software running on said first information device further adapted to enable the user of the first information device to include media with said request.

5. The method of claim 1, wherein:
said content request software running on said first information device further adapted to enable the user of the first information device to include an expiration time with said request.
